(19) United States
(12) Patent Application Publication
(10) Pub. No.: US 2026/0113210 A1
(43) Pub. Date: Apr. 23, 2026

(54) INTERACTIVE SPATIAL COMMENTING WITH EXTERNAL REVIEW INTEGRATION FOR VIRTUAL MEETINGS

(71) Applicant: Cisco Technology, Inc., San Jose, CA (US)

(72) Inventors: Rakshita CHAUDHARY, Wakad (IN); Chinta Satya NARASIMHA BHARGAV, Kompally (IN); Faisal SIYAVUDEEN, Ponekkara (IN)

(21) Appl. No.: 18/922,700

(22) Filed: Oct. 22, 2024

(51) Int. Cl. H04L 12/18; G06F 3/14; G06F 40/103; G06F 40/169; H04L 65/1089; H04L 65/1093

(52) U.S. Cl. CPC H04L 12/1831; G06F 3/1454; G06F 40/103; G06F 40/169; H04L 65/1089; H04L 65/1093

(57) ABSTRACT

In one embodiment, a method for interactive spatial commenting with external review integration for virtual meetings includes determining one or more attributes associated with screenshare content displayed by a computer application to determine a document type associated with the screenshare content and receiving an input from one or more participants in a meeting hosted by the computer application. The input corresponds to a comment made by the one or more participants in the meeting regarding the screenshare content. The method further includes adding the comment to the screenshare content at a particular location within the screenshare content based, at least in part, on a time at which the comment was made in the meeting and processing the screenshot content to store the information at the location within the screenshare content based, at least in part, on the document type associated with the screenshare content associated with the screenshare content.

### TECHNICAL FIELD

The present disclosure relates generally to computer networks, and, more particularly, to interactive spatial commenting with external review integration for virtual meetings.

### BACKGROUND

In virtual meetings (e.g., videoconferences) content, such as documents, applications, etc. can be shared so that the participants of such virtual meetings can see and discuss the shared content. In order to enhance discussion of this type of content, it may be possible to add comments to the virtual meeting using a supplied chat function whereby the participants can type comments, questions, or other text for the participants to read. In addition, some contemporary virtual meetings allow for comments made orally to be presented in a transcript, which can optionally be extracted with the assistance of artificial intelligence techniques.

These types of comments can be associated with a timestamp indicating a time at which the comment was made during the virtual meeting. However, in order to understand the context of content presented during the virtual meeting at the time at which a comment was made, a participant may either be required to remember the circumstances during which the comment was made or the participant may be required to listen to a recording (or at least a portion of a recording) of the virtual meeting to place the comment in the context of the content being discussed at the time the comment was made

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates various example components of an illustrative videoconferencing system;

FIG. 4 illustrates an example display of a virtual meeting (or a videoconference);

FIG. 5 illustrates an example system for interactive spatial commenting with external review integration for virtual meetings;

FIG. 6 illustrates an example flow for adding information to content provided by a client in accordance with the disclosure;

FIG. 7 illustrates an example flow for adding information to content hosted by a server in accordance with the disclosure; and

FIG. 8 illustrates an example procedure for interactive spatial commenting with external review integration for virtual meetings.

### DESCRIPTION OF EXAMPLE EMBODIMENTS

### Overview

According to one or more embodiments of the disclosure, a method for interactive spatial commenting with external review integration for virtual meetings includes determining, by a process, one or more attributes associated with screenshare content displayed by a computer application to determine a document type associated with the screenshare content and receiving, by the process, an input from one or more participants in a meeting hosted by the computer application. The input corresponds to a comment made by the one or more participants in the meeting regarding the screenshare content. The method further includes adding, by the process, the comment to the screenshare content at a particular location within the screenshare content based, at least in part, on a time at which the comment was made in the meeting and processing, by the process, the screenshot content to store the information at the location within the screenshare content based, at least in part, on the document type associated with the screenshare content associated with the screenshare content.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

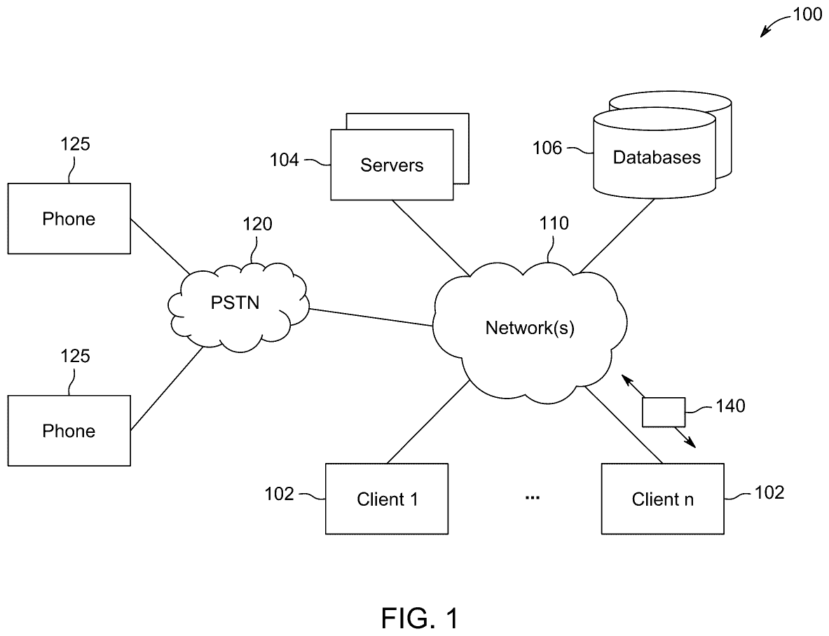

FIG. 1 is a schematic block diagram of an example computing system 100 illustratively comprising client devices (e.g., client devices 102, which may include a first through nth client device), servers 104 (e.g., one or more servers), and databases 106 (e.g., one or more databases), where the devices may be in communication with one another via one or more networks (e.g., network(s) 110). The network(s) 110 may include, as would be appreciated, any number of specialized networking devices such as routers, switches, access points, etc., interconnected via wired and/or wireless connections. For example, client devices 102, servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, collaboration endpoints, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

In addition, a separate public switched telephone network (PSTN 120) may also be considered to be a part of computing system 100, namely where phones 125 connect to the PSTN 120 in a standard manner (e.g., landlines, cellphones, and so on). The PSTN may be based on any number of carrier telephone networks which provide a connection to network(s) 110 for things such as conference calls, video calls, calls to voice over IP (VoIP) end points, and so on, as will be readily understood by those skilled in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

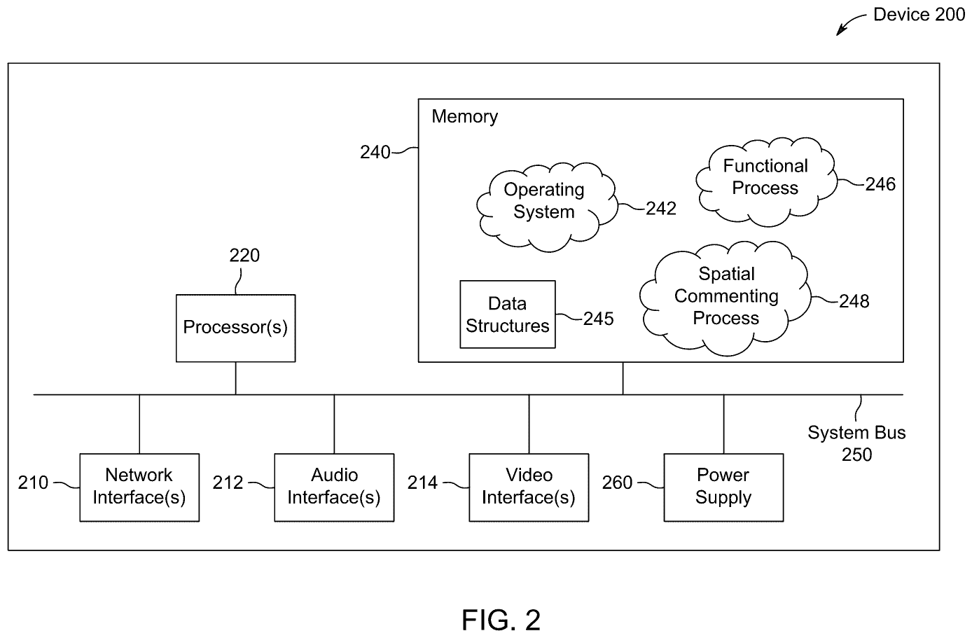

FIG. 2 is a schematic block diagram of an example node such as device 200 (e.g., an apparatus) that may be used with one or more embodiments described herein, e.g., as any of the client devices 102, servers 104, databases 106 shown in FIG. 1 above. Device 200 may also be any other suitable type of device depending upon the type of network architecture in place, such as a collaboration endpoint, “receiver” (herein), etc. Device 200 may comprise one or more network interfaces (e.g., interfaces 210), one or more audio interfaces (e.g., audio interfaces 212), one or more video interfaces (e.g., video interfaces 214), one or more processors (e.g., processor(s) 220), and a memory 240 interconnected by a system bus 250, and is powered by a power supply 260.

The network interfaces (e.g., interfaces 210) include the mechanical, electrical, and signaling circuitry for communicating data over physical links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

The audio interfaces 212 may include the mechanical, electrical, and signaling circuitry for transmitting and/or receiving audio signals to and from the physical area in which a device 200 is located. For instance, audio interfaces 212 may include one or more speakers and associated circuitry to generate and transmit soundwaves. Similarly, audio interfaces 212 may include one or more microphones and associated circuitry to capture and process soundwaves.

The video interfaces 214 may include the mechanical, electrical, and signaling circuitry for displaying and/or capturing video signals. For instance, video interfaces 214 may include one or more display screens. At least one of the display screens may comprise a touch screen, such as a resistive touchscreen, a capacitive touchscreen, an optical touchscreen, or other form of touchscreen display, to allow a user to interact with device 200. In addition, video interfaces 214 may include one or more cameras, allowing device 200 to capture video of a user for transmission to a remote device via interfaces 210. Such cameras may be mechanically controlled, in some instances, to allow for repositioning of the camera, automatically.

The memory 240 comprises a plurality of storage locations that are addressable by the processor(s) 220 and the interfaces 210 (e.g., network interfaces) for storing software programs and data structures associated with the embodiments described herein. The processor(s) 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise one or more functional processes 246, and on certain devices, a spatial commenting process (e.g., process 248), as described herein. Notably, one or more functional processes 246, when executed by processor(s) 220, cause each particular device (e.g., device 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

For web-based conferencing services, such as a videoconference, teleconference, one-on-one (e.g., VoIP) calls, and so on, the one or more functional processes 246 may be configured to allow device 200 to participate in a virtual meeting/conference during which, for example, audio data captured by audio interfaces 212 and optionally video data captured by video interfaces 214 is exchanged with other participating devices of the virtual meeting (or a videoconference) via interfaces 210. In addition, conferencing processes may provide audio data and/or video data captured by other participating devices to a user via audio interfaces 212 and/or video interfaces 214, respectively. As would be appreciated, such an exchange of audio and/or video data may be facilitated by a web conferencing service (e.g., Webex by Cisco Systems, Inc., etc.) that may be hosted in a data center, the cloud, or the like.

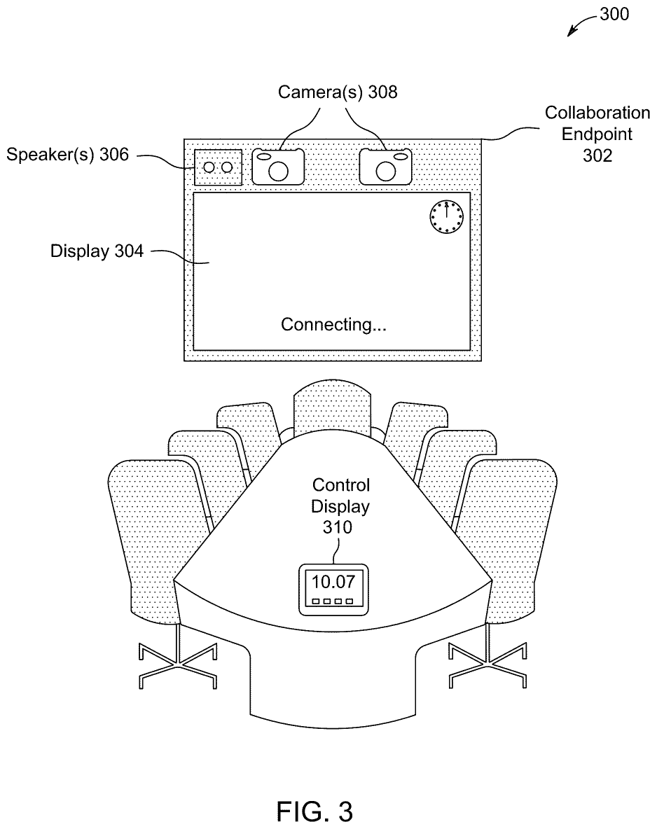

For instance, FIG. 3 illustrates an example meeting room 300 in which a collaboration endpoint 302 is located, according to various embodiments. During operation, collaboration endpoint 302 may capture video via its one or more cameras 308, audio via one or more microphones, and provide the captured audio and video to any number of remote locations (e.g., other collaboration endpoints) via a network. Such videoconferencing may be achieved via a videoconferencing/management service located in a particular data center or the cloud, which serves to broker connectivity between collaboration endpoint 302 and the other endpoints for a given meeting. For instance, the service may mix audio captured from different endpoints, video captured from different endpoints, etc., into a finalized set of audio and video data for presentation to the participants of a virtual meeting (or a videoconference). Accordingly, collaboration endpoint 302 may also include a display 304 and/or speakers 306, to present such data to any virtual meeting (or a videoconference) participants located in meeting room 300.

Also as shown, a control display 310 may also be installed in meeting room 300 that allows a user to provide control commands for collaboration endpoint 302. For instance, control display 310 may be a touch screen display that allows a user to start a virtual meeting, make configuration changes for the videoconference or collaboration endpoint 302 (e.g., enabling or disabling a mute option, adjusting the volume, etc.).

In some cases, any of the functionalities of collaboration endpoint 302, such as capturing audio and video for a virtual meeting (or a videoconference), communicating with a videoconferencing service, presenting videoconference data to a virtual meeting participant, etc., may be performed by other devices, as well. For instance, a personal device such as a laptop computer, desktop computer, mobile phone, tablet, or the like, may be configured to function as an endpoint for a videoconference (e.g., through execution of a videoconferencing client application), in a manner similar to that of collaboration endpoint 302.

### Iteractive Spatial Commenting with Review Integration for Virtual Meetings

As noted above, virtual meeting platforms can allow for comments (either input using a chat function or spoken, often with the assistance of artificial intelligence techniques) to be added to a virtual meeting recording within the virtual meeting platform itself. However, such comments are not automatically associated with the specific content shown on screen, and this association is often therefore made through human understanding. Using the techniques of such approaches, it is not currently possible to make comments that are specifically associated with content that is displayed on a portion of a shared screen via which the participants are viewing the virtual meeting. Further, because the comments are generally associated with the virtual meeting platform (as opposed to the content shared in the virtual meeting), current approaches do not allow for the comments made during the meeting to be provided within the content or application associated with the content in such a way that the association between the comments and the entities in the application document is preserved.

For example, suppose a participant in a virtual meeting is sharing a PowerPoint slide (i.e., “content”) and the participants are discussing a particular diagram on the slide. The participants would understand that the comments made in the chat or orally are related to the particular diagram. However, the comments, along with this association, are generally not moved to the shared document (or as a layer that can be displayed over the document) when it is opened in PowerPoint because the chat or oral comments are preserved only within the virtual meeting application. Similar situations might occur with tools like Miro, Figma, Jira, Confluence, GitHub, Microsoft® Word, etc. participants who want comments to be associated with visual elements would have to make those comments as text, inside the shared application itself in order to preserve the same once the virtual meeting has concluded. This requires the participants to open the applications either in standalone mode or as an embedded application and, even if the participant(s) undertake these additional, time-consuming steps, voice comments would generally not naturally be added to the content.

The techniques herein therefore allow for any participant in a virtual meeting to attach metadata to specific visual elements being shared in a meeting, that is then used for filtering during display by other participants. In some implementations, each aspect of the element can be represented as a feature, that allows display filtering using an artificial intelligence model.

That is, the techniques herein allow for virtual meeting participants to add spatial comments (i.e., comments, images, etc.) to content shared in a virtual meeting. As used herein, “spatial comments” generally refer to comments that have a specific timestamp, specific location in a document, etc. As discussed in more detail below, the techniques described herein further allow for the content with the spatial comments to be provided for view outside of the virtual meeting application, for example, within the application that the content is stored in after the virtual meeting instance has concluded.

Specifically, according to one or more embodiments of the disclosure as described in detail below, a method for interactive spatial commenting with external review integration for virtual meetings includes determining, by a process, one or more attributes associated with screenshare content displayed by a computer application to determine a document type associated with the screenshare content and receiving, by the process, an input from one or more participants in a meeting hosted by the computer application.

The input corresponds to a comment made by the one or more participants in the meeting regarding the screenshare content. The method further includes adding, by the process, the comment to the screenshare content at a particular location within the screenshare content based, at least in part, on a time at which the comment was made in the meeting and processing, by the process, the screenshot content to store the information at the location within the screenshare content based, at least in part, on the document type associated with the screenshare content associated with the screenshare content.

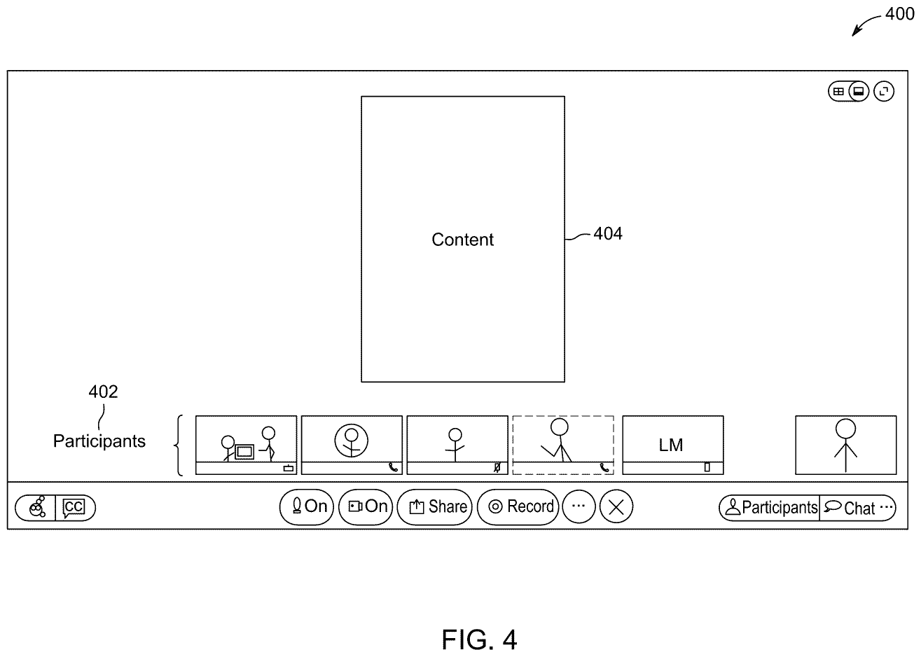

Operationally, FIG. 4 illustrates an example display of a virtual meeting (or a videoconference). As shown, video for participants 402 may be presented in conjunction with content 404. For instance, video data for each of participants 402 (e.g., video captured by each of their respective cameras) may be presented along the bottom of the displayed conference, along a side of the displayed conference, or the like. Typically, the host or presenter of the videoconference may be displayed in a prominent location on screen 400, with their video appearing much larger than that of participants 402. This may be considered a stage or presenter mode of the virtual meeting. However, other presentation modes are contemplated, for instance, where each participant shares an equal amount of the displayed conference, or where the current speaker is shown in the prominent view.

Other styles, configurations, and operations of web conferences, presentations, calls, and so on may be understood by those skilled in the art, and those shown and described above are merely examples that are not meant to be limiting to the scope of the present disclosure.

In particular and in accordance with the disclosure, the content 404 can be displayed in a prominent location on the screen 400 (e.g., a display) as opposed to the presenter. This can be achieved through the use of screen sharing, document sharing, or other techniques in which one or more of the participants 402 causes the content 404 to be displayed in a prominent location on the screen 400 for view and/or discussion amongst the participants 402. As discussed in more detail herein, the content 404 can be a document (e.g., a Microsoft® Word Document, Portable Document Format document, etc.), application, shared document, or other editable document or application that can be displayed on the screen 400.

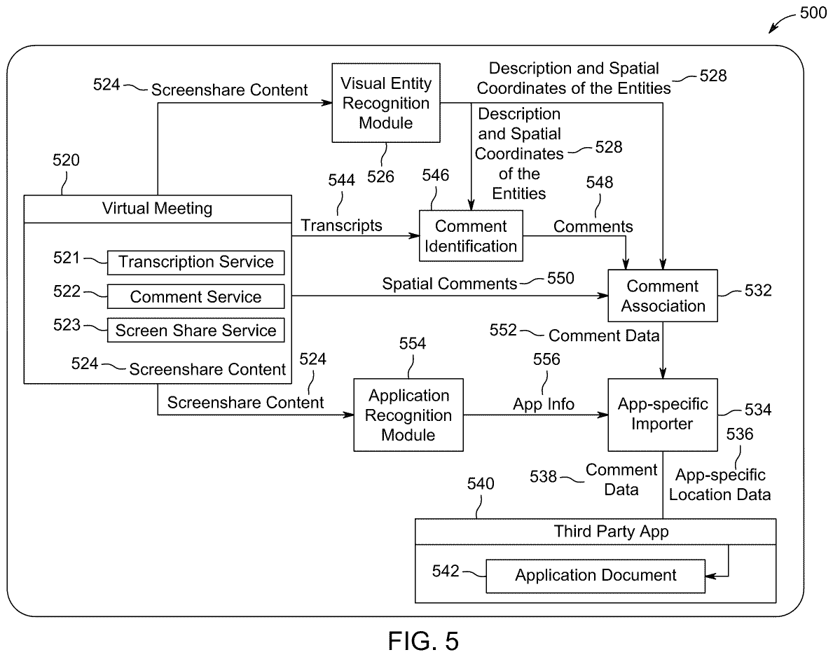

FIG. 5 illustrates an example system for interactive spatial commenting with external review integration for virtual meetings. The system 500 includes a virtual meeting 520. As mentioned above, the virtual meeting 520 can be a videoconference that is executed by an application, such as Webex by Cisco® or other similar virtual meeting as discussed above in connection with FIG. 4. As shown in FIG. 5, the virtual meeting 520 can include a transcription service 521, a comment service 522, and a screenshare service 523. The transcription service 521 can be configured to generate a transcript of the virtual meeting 520 (e.g., a written record of the oral discussion that occurred during the virtual meeting 520). In some implementations, the transcription service 521 can utilize artificial intelligence techniques to generate the transcript.

The comment service 522 is configured to display comments inputted by participants of the virtual meeting 520 on one or more display devices used by the participants. In some implementations, the comment service 522 can display these comments in a chat (e.g., a chat window) that can be viewed by the participants in the virtual meeting 520. The screenshare service 523 can be configured to allow participants in the virtual meeting 520 to display screenshare content 524 (e.g., the content 404 discussed above in connection with FIG. 4) in the virtual meeting 520 so that all the participants are able to view the screenshare content 524 on, for example the display devices used by the participants.

As shown in FIG. 5, the screenshare content 524 can be provided to a visual entity recognition module 526 and an application recognition module 554. The visual entity recognition module 526 can be configured to generate descriptions of entities (e.g., objects, images, text, etc.) associated with the screenshare content 524, along with information on the location at which the entities are displayed within the screenshare content 524. In some implementations, the visual entity recognition module 526 can utilize artificial intelligence techniques to generate the descriptions of the entities and/or the location at which the entities are displayed.

As shown in FIG. 5, the visual entity recognition module 526 can, at operation 528, generate a description and/or spatial coordinates of the entities displayed within the screenshare content 524. The description and/or spatial coordinates of the entities displayed within the screenshare content 524 can be sent to a comment identification module 546 and a comment association module 532. In some implementations, the comment identification module 546 can be configured to execute a large-language model to compare the text in the conversation stream (e.g., the chat provided via the comment service 522) and identify portions that pertain to specific entities shared on the display device by comparing the caption text with entity descriptions.

In addition, the comment identification module 546 can be configured to associate text and/or voice comment inputs with the entities presented on the display device. In some implementations, the comment identification module 546 can use specific user interface (UI) modalities within the virtual meeting window to associate entities on the display device with the text and/or voice comment inputs. Further, the comment identification module 546 can, as shown at operation 544, receive transcripts generated by the transcription service 521. These transcripts can be processed by the comment identification module 546 as part of associating the text and/or voice comment inputs with the entities presented on the display device.

In some implementations, the comment identification module 546 can be configured to receive an audio (e.g., oral or other auditory) comment. Such audio comments can be processed using an intermediate service (e.g., artificial intelligence techniques) to associate the audio comment with specific content corresponding thereto. As shown at operation 548, comments (e.g., the text and/or voice comment inputs associated with the entities presented on the display device) that have been generated by the comment identification module 546 can be provided to a comment association module 532. In addition, the comment association module 532 can receive spatial comments (e.g., comments with associated spatial information corresponding to a timestamp and/or location in the screenshare content 524, as shown at operation 550, from the comment service 522 associated with the virtual meeting 520. As shown in FIG. 5, the comment association module 532 can process these inputs to generate comment data (as shown at operation 552). This comment data can then be provided to an application-specific importer module 534.

Returning now to the application recognition module 554, in some implementations, the application recognition module 554 can be configured to process the screenshare content 524 to determine an application associated with the screenshare content 524. For example, the application recognition module 554 can process file extensions, metadata, or other information contained in the screenshare content 524 to determine the application associated with the screenshare content 524. Non-limiting examples of applications associated with the screenshare content 524 that the application recognition module 554 can determine can include Word documents, PowerPoint documents, portable document format (PDF) documents, web-based document formats, etc. Once the application recognition module 554 has determined the application associated with the screenshare content 524, the application recognition module 554 can, as shown at operation 556, provide the application info (e.g., “app info”) to the application-specific importer module 534.

In some implementations, the application-specific importer module 534 can convert the spatial coordinates of the entities, spatial comments, comment data, and application info to location and comment data inside the application document (e.g., the screenshare content 524). For instance, in the case where the screenshare content 524 is a PowerPoint document, the on-screen location information might contain the slide number, slide extents in pixels, and the entity bounding box in pixels, among other information. In this non-limiting example, the application-specific importer module 534 can then convert this information into the slide number, and bounding box in units that are relevant to PowerPoint. It will be appreciated that similar techniques can be performed for other types of screenshare content 524 and the example with PowerPoint is merely used to elucidate aspects of the present disclosure.

As shown at operation 536 and operation 538, respectively, the application-specific location data and the comment data can be provided to a third-party application 540 where an application document 542 including the information discussed above can be stored. In some implementations, the third-party application 540 can be the application that was used to create the screenshare content 524 and the application document 542 can be the document that was shared during the virtual meeting 520.

Notably, the application document 542 can include the spatial content discussed above as processed by the system 500. For example, the application document 542 can include spatial comments (both those entered in the chat functionality and those spoken orally) from the virtual meeting, as well as images, notes, etc. that were added to the screenshare content 524 during the virtual meeting. This can allow for a reduction in time spent curating the content shared during the meeting on the back end, thereby increasing meeting productivity and reducing stress and additional labor on the part of the meeting participants who would normally be required to manually enter such information into the application document 542.

To provide another non-limiting example in accordance with the disclosure, consider that a virtual meeting with video streams, captions and shared content is like a document. The shared content itself might be applications shared as video, or as embedded apps supported by the virtual meeting platform. As mentioned above, the virtual meeting platform can allow participants to click, type, and/or touch to add comments (either text-based, image-based, or orally spoken) to any visual element shown on the display device while they are in the virtual meeting. In the case of voice comments, the virtual meeting platform can allow participants to add voice comments without the comments interfering the voice content in the meeting. The voice comments may also be optionally transcribed and converted into text comments. It is also possible that general voice conversation in the meeting can be transcribed live, and comments extracted from this transcription stream can be added as comments to the content. In the case where a participant is not specifically pointing or touching on a visual element, the virtual meeting platform can then analyze the comment text, identify entities on screen, and attempt to associate comments to specific entities, as discussed above.

Once the comments and the in-document location of the entity are identified, this association can either be imported into the application document that is being shared, or it can be saved as a separate document. When the document is opened in the application later, the comments would be available in the application itself, along with other in-app comments. The imported comments can also be associated to specific locations in the application document, to the extent that the application allows.

If the content is an application shared as an embedded app, text comments can be made naturally in the app itself. However, specific voice comments and comments extracted from conversation would still have to be imported as mentioned above.

In another non-limiting example, a Microsoft® Word document can be shared in a virtual meeting. Once the entity on the display device is identified as described above, the entity can be matched against a corresponding entity in the Word document - either as text or as an image, depending on the content. The comment can also be inserted at the right location in the document using an application programming interface (API).

The API can be either native to the application or a bespoke API. Some non-limiting examples of APIs native to the application can include Confluence, JIRA, Figma etc., all of which expose APIs to interact with content.

In the case where the application does not expose a native API, extracted information gathered as discussed above can be stored an overlay, mapped against window information (e.g., size, scroll position, geometry, etc.) such that the information can be re-displayed by writing an overlay viewer to open and display the document. It will be appreciated that, in such cases, there may be some limitations, such as the possibility that the spatial comments may be viewed and “read-only,” however, it is contemplated within the scope of the disclosure that additional back-end modifications can be made to such content to allow further participant control of the spatial comments that are generated as described herein.

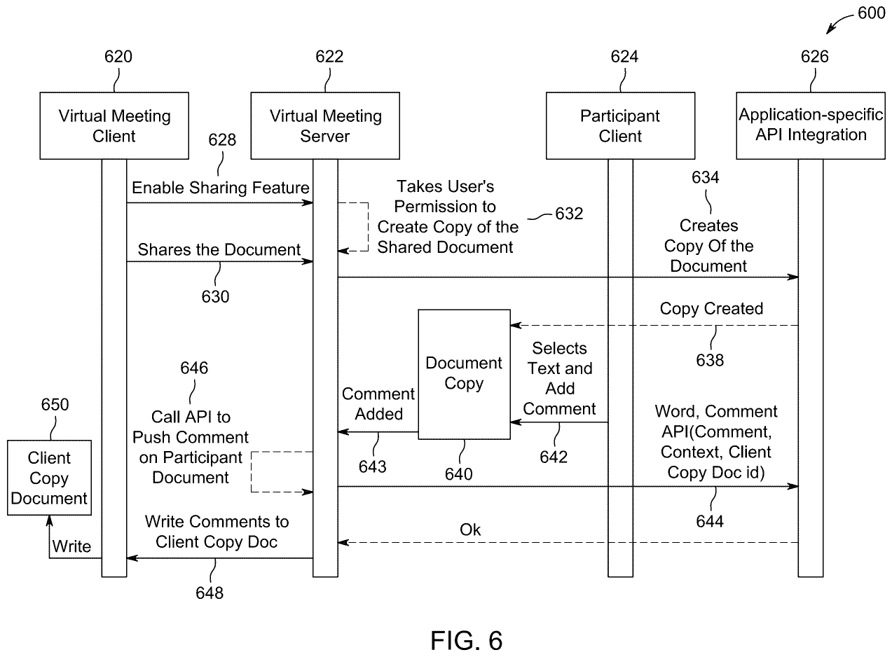

That being said, implementations herein can utilize traits and features of applications, particularly access permissions, to facilitate the features disclosed (as discussed in more detail in connection with FIG. 6, herein). For example, and continuing with the non-limiting Microsoft® Word example above, the participant who is sharing the Word document has access to the document. As long as this participant has copy permission, a copy of the document may be generated with this participant's permission and comments can be transmitted to the participant's client and inserted into the document copy from the participant. It will be appreciated that the same approach can be followed in the case of JIRA, Figma, and many others.

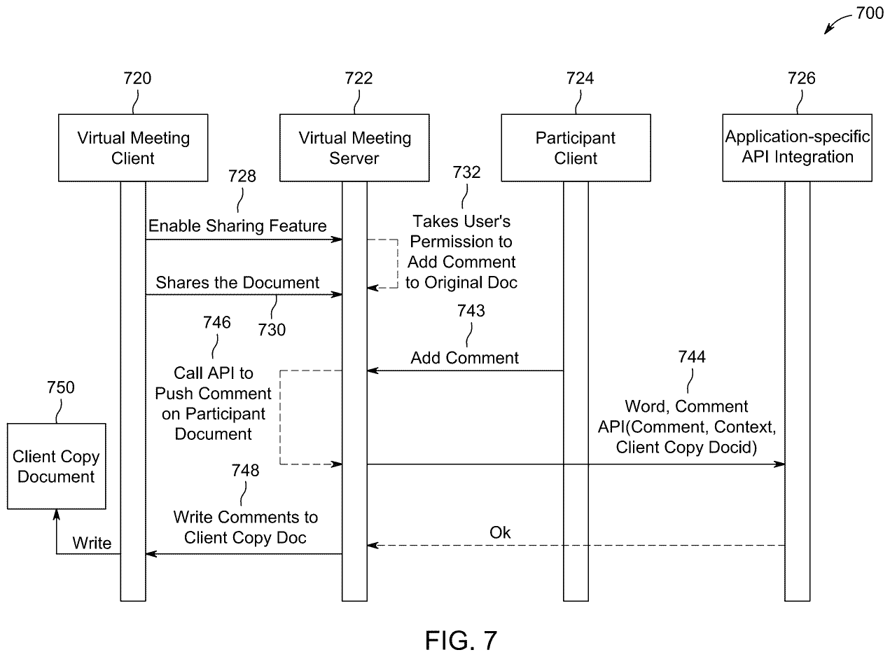

It is also noted that, in accordance with the disclosure, it is possible to take a server-side approach (discussed in more detail in connection with FIG. 7, herein), where the sharing user is asked to provide permission to a server-side integration to, for example, Office365 or Jira to create a copy of the document and store comments. In all these cases, it is possible to add comments to the original document provided that the sharing participant grants appropriate permissions. In these cases, enabling spatial comments and exportation to application documents can become features of the virtual meeting and specific permission would be sought from sharing participants only in certain circumstances.

FIG. 6 illustrates an example flow for adding information to content provided by a client in accordance with the disclosure. The flow 600 of FIG. 6 generally addresses a scenario in which the spatial comments discussed above are added to the copy of the content provided by the participant that is sharing said content in the virtual meeting, as mentioned above.

As shown in FIG. 6, a virtual meeting client 620 (e.g., a virtual meeting platform, such as Webex provided by Cisco®, etc.) can be hosted on a virtual meeting server 622. The virtual meeting client 620 can facilitate the virtual meetings discussed above, while the virtual meeting server 622 can be a pool of physical computing resources that executes machine-readable instructions to run the virtual meeting client 620.

In addition, a participant of the virtual meeting can access the virtual meeting from a participant client 624, which can be a local device (e.g., a personal computer, laptop, tablet, smartphone, phablet, etc.) that the participant is using to access the virtual meeting. Further, as shown in FIG. 6, the participant client 624 can be in communication with application-specific API integration 626, which can be accessed by virtue of the participant having the content stored on the participant client 624. That is, the participant sharing the content (e.g., the screenshare content 524) as described above can have said content saved on their local machine (e.g., the participant client 624) and, accordingly, that participant can access an application-specific API integration 626 associated with the application corresponding to the content.

At operation 628, the virtual meeting client 620 can enable a sharing feature for the virtual meeting server 622. In response to enabling the sharing feature, the virtual meeting client 620 can cause a document (e.g., the screenshare content) to be shared with the virtual meeting server 622. The virtual meeting server 622 can then, as shown at operation 632, use permissions associated with a user that has created (or has access to) a shared document (e.g., the screenshare content) to make a copy of the shared document.

At operation 634, a copy of the shared document is created and provided to the participant client 624 and/or the application-specific API integration 626. At operation 638, the created copy of the document (e.g., the document copy 640) can be displayed using the virtual meeting server 622 for viewing on the participant client 624. In accordance with the disclosure above, participants in the virtual meeting can add comments, as shown at operation 642 and/or at operation 643. At operation 646, the comments can be pushed using, for example an API call, to the participant document, thereby incorporating the comment into the participant document.

At operation 644, the comments that were added to the participant document can be pushed to the application-specific API integration 626. Once the comments have been processed by the application-specific API integration 626, at operation 648, the comments can be written to the participant's copy of the document to generate a client copy document 650. In some implementations, the client copy document 650 can be analogous to the application document 542 discussed above in connection with FIG. 5.

FIG. 7 illustrates an example flow for adding information to content hosted by a server in accordance with the disclosure. The flow 700 of FIG. 7 generally addresses a scenario in which the spatial comments discussed above are added to the copy of the content hosted on a server when the content is shared in the virtual meeting, as mentioned above.

As shown in FIG. 7, a virtual meeting client 720 (e.g., a virtual meeting platform, such as Webex provided by Cisco®, “Teams” provided by Microsoft®, etc.) can be hosted on a virtual meeting server 722. The virtual meeting client 720 can facilitate the virtual meetings discussed above, while the virtual meeting server 722 can be a pool of physical computing resources that executes machine-readable instructions to run the virtual meeting client 720.

In addition, a participant of the virtual meeting can access the virtual meeting from a participant client 724, which can be a local device (e.g., a personal computer, laptop, tablet, smartphone, phablet, etc.) that the participant is using to access the virtual meeting. Further, as shown in FIG. 7, the participant client 724 can be in communication with application-specific API integration 726, which can be accessed by virtue of the participant having the content stored on the participant client 724. That is, the participant sharing the content (e.g., the screenshare content 524) as described above can have said content saved on their local machine (e.g., the participant client 724) and, accordingly, that participant can access an application-specific API integration 726 associated with the application corresponding to the content.

At operation 728, the virtual meeting client 720 can enable a sharing feature for the virtual meeting server 722. In response to enabling the sharing feature, the virtual meeting client 720 can cause a document (e.g., the screenshare content) to be shared with the virtual meeting server 722. The virtual meeting server 722 can then, as shown at operation 732, use permissions associated with a user that has created (or has access to) a shared document (e.g., the screenshare content) to make a copy of the shared document.

At operation 743, a comment (e.g., from a user of the participant client 724) can be added to the document. At operation 746, the comments can be pushed using, for example an API call, to the participant document, thereby incorporating the comment into the participant document. At operation 744, the comments that were added to the participant document can be pushed to the application-specific API integration 726. Once the comments have been processed by the application-specific API integration 726, at operation 748, the comments can be written to the participant's copy of the document to generate a client copy document 750. In some implementations, the client copy document 750 can be analogous to the application document 542 discussed above in connection with FIG. 5.

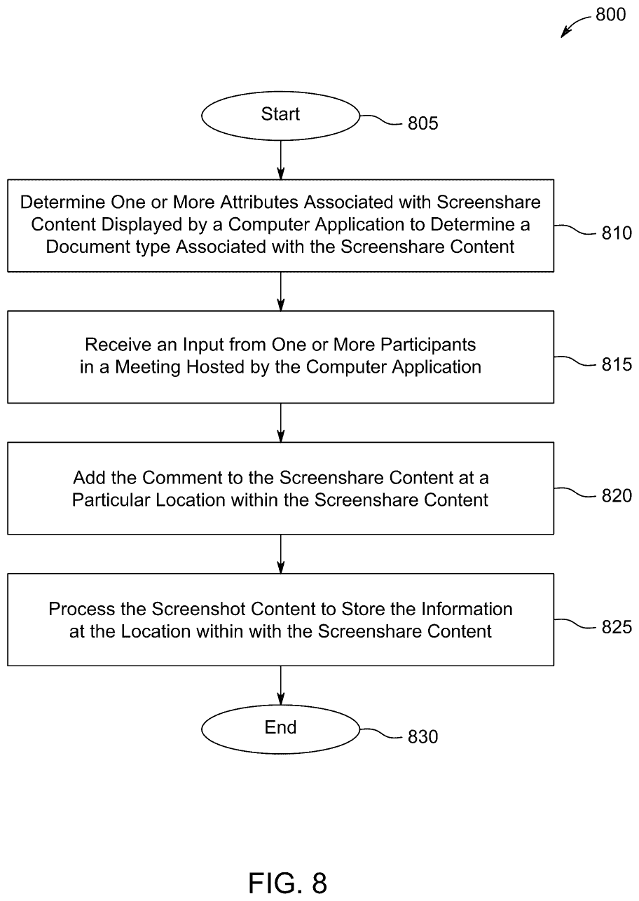

In closing, FIG. 8 illustrates an example procedure for interactive spatial commenting with external review integration for virtual meetings in accordance with one or more embodiments described herein. For example, a non-generic, specifically configured device (e.g., device 200, an apparatus) may perform procedure 800 by executing stored instructions (e.g., process 248). The procedure 800 may start at step 805, and continues to step 810, where, as described in greater detail above, one or more attributes associated with screenshare content displayed by a computer application are determined by a process to determine a document type associated with the screenshare content.

In some implementations, the one or more attributes associated with the screenshare content comprise a file extension associated with an application that was used to create the screenshare content. For example, the file extension can correspond to a Word Document (e.g., a file extension ending in. doc,. docx, etc.), a PowerPoint Document (e.g., a file extension ending in. ppt,. pptx, etc.), a Portable Document Format Document (e.g., a file extension ending in. pdf), and so on and so forth. Further, as discussed above, in some implementations, the computer application can be a virtual meeting application that provides videoconferencing services to multiple participants.

The procedure 800 may continue to step 815 where, as described in greater detail above, an input from one or more participants in a meeting hosted by the computer application are received by the process. In some implementations, the input corresponds to a comment made by the one or more participants in the meeting regarding the screenshare content. In some implementations, the input can be a voice input (e.g., a spoken/oral comment) and the process can determine the particular location based on the voice input.

The procedure 800 may continue to step 820 where, as described in greater detail above, the comment is added by the process to the screenshare content at a particular location within the screenshare content based, at least in part, on a time at which the comment was made in the meeting. In some implementations, the particular location can comprise a location selected from a group comprising a spatial location or a temporal location. In some implementations, the procedure 800 can further include adding the comment to the screenshare content at the particular location using an artificial intelligence model. For example, an artificial intelligence model may be executed to associate the input to the particular location and assist in adding the comment to the screenshare content at that particular location.

In some implementations, the comment can be added to the screenshare content at a particular location within the screenshare content by executing a visual entity recognition module that is configured to associate an entity associated with the screenshare content and the input. For example, the visual entity recognition module could determine that a participant is talking about an image (e.g., a logo) that is being displayed in the virtual meeting. In such implementations, the visual entity recognition module can be executed to locate the image based on the oral discussion surrounding the image and associate the comment at the right place (e.g., the correct spatial location) in the document.

The procedure 800 may continue to step 825 where, as described in greater detail above, the screenshare content is processed by the process to store the comment at the location within the screenshare content based, at least in part, on the document type associated with the screenshare content. In some implementations, the procedure 800 can further include translating, by the process, the comment into a format that is compatible with the document type. For example, if the document type is a Microsoft Word document, the process can translate the comment into a format that is compatible with Microsoft Word so that the comment can be saved in or otherwise embedded in the document.

In some implementations, the computer application can comprise a virtual meeting application, and the procedure 800 can further include processing, by the process, the content to include the screenshare content and the comment at the particular location associated with the screenshare content in a recording of a virtual meeting conducted using the virtual meeting application and displaying the screenshare content and the comment at the particular location associated with the screenshare content during playback of the recording of the virtual meeting. In some implementations, the computer application can comprise a virtual meeting application, and the procedure 800 can further include adding the information to the screenshare content based on the input from the one or more participants at the particular location associated with the content without interfering with the virtual meeting.

In some implementations, the computer application can comprise a virtual meeting application, and the procedure 800 can further include processing, by the process, the screenshare content to include the screenshare content and the comment at the particular location associated with the screenshare content in a recording of a virtual meeting conducted using the virtual meeting application and providing real-time updates associated with the screenshare content and the comment at the particular location associated with the comment to participants that are not in the virtual meeting. For example, implementations herein can allow for the virtual meeting to be recorded with the screenshare content saved as the screenshare content appeared during the virtual meeting and the recording can be played back at a later time by participants who were either in the virtual meeting or not in the virtual meeting. These participants can then further edit the screenshare content in the recording if they so choose.

Procedure 800 may end at step 830.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: determining one or more attributes associated with screenshare content displayed by a computer application to determine a document type associated with the screenshare content; receiving an input from one or more participants in a meeting hosted by the computer application, wherein the input corresponds to a comment made by the one or more participants in the meeting regarding the screenshare content; adding the comment to the screenshare content at a particular location within the screenshare content based, at least in part, on a time at which the comment was made in the meeting; and processing the screenshare content to store the comment at the particular location within the screenshare content based, at least in part, on the document type associated with the screenshare content.

In still other implementations, a tangible, non-transitory, computer-readable medium storing program instructions that cause a device to execute a process comprising: determining, by a process, one or more attributes associated with screenshare content displayed by a computer application to determine a document type associated with the screenshare content; receiving, by the process, an input from one or more participants in a meeting hosted by the computer application, wherein the input corresponds to a comment made by the one or more participants in the meeting regarding the screenshare content; adding, by the process, the comment to the screenshare content at a particular location within the screenshare content based, at least in part, on a time at which the comment was made in the meeting; and processing, by the process, the screenshare content to store the comment at the particular location within the screenshare content based, at least in part, on the document type associated with the screenshare content.

The techniques described herein, therefore, provide for interactive spatial commenting with external review integration for virtual meetings. As discussed above, the techniques herein allow for virtual meeting participants to add spatial comments (i.e., comments, images, etc.) to content shared in a virtual meeting. The techniques described herein further allow for the content with the spatial comments to be provided for view outside of the virtual meeting application, for example, within the application that the content is stored in after the virtual meeting instance has concluded. These and other features can improve the efficacy of virtual meetings by preserving the comments and information added to content in real-time during the virtual meeting for later discussion, revision, or other use.

In some implementations, as described above, aspects of the present disclosure allow for:
Participants in a virtual meeting to spatially associate comments with visual elements within shared content in real-time, without interfering with the ongoing meeting;
Functionality in the meeting platform to enable such association, facilitating interactive discussions and feedback on the shared content, during the meeting, and after the meeting using specific applications;
Translating spatially associated comments and areas of interest into one or more formats importable into external software applications for offline reviewing post-meeting, and a functionality within the meeting platform to enable such translation and export;
Including the comments and information about their temporal and spatial association with visual elements in shared content, into the meeting recording, and a functionality in the meeting platform for enable such inclusion; and
Displaying the comments and information about their temporal and spatial association with visual elements in shared content, during playback of meeting recordings, and a functionality in the meeting platform for enable such display.

Illustratively, the techniques described herein may be performed by hardware, software, and/or firmware, (e.g., an “apparatus”) such as in accordance with the spatial commenting process, process 248 (e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by a process, one or more attributes associated with screenshare content displayed by a computer application to determine a document type associated with the screenshare content;
receiving, by the process, an input from one or more participants in a meeting hosted by the computer application, wherein the input corresponds to a comment made by the one or more participants in the meeting regarding the screenshare content;
adding, by the process, the comment to the screenshare content at a particular location within the screenshare content based, at least in part, on a time at which the comment was made in the meeting; and
processing, by the process, the screenshare content to store the comment at the particular location within the screenshare content based, at least in part, on the document type associated with the screenshare content.

2. The method of claim 1, wherein the one or more attributes associated with the screenshare content comprise a file extension associated with an application that was used to create the screenshare content.

3. The method of claim 1, wherein the computer application comprises a virtual meeting application, and wherein the method further comprises:
processing, by the process, the screenshare content to include the screenshare content and the comment at the particular location associated with the screenshare content in a recording of a virtual meeting conducted using the virtual meeting application; and
providing real-time updates associated with the screenshare content and the comment at the particular location associated with the comment to participants that are not in the virtual meeting.

4. The method of claim 1, wherein the input comprises a voice input and wherein the method further comprises:
determining, by the process, the particular location based on the voice input.

5. The method of claim 1, wherein the computer application comprises a virtual meeting application, and the method further comprises:
processing, by the process, the screenshare content to include the screenshare content and the comment at the particular location associated with the screenshare content in a recording of a virtual meeting conducted using the virtual meeting application; and
displaying the screenshare content and the comment at the particular location associated with the comment during playback of the recording of the virtual meeting.

6. The method of claim 1, wherein the computer application comprises a virtual meeting application executing a virtual meeting, and the method further comprises:
adding the comment to the screenshare content based on the input from the one or more participants at the particular location associated with the screenshare content without interfering with the virtual meeting.

7. The method of claim 1, wherein the particular location comprises a location selected from a group consisting of a spatial location or a temporal location.

8. The method of claim 1, further comprising:
adding the comment to the screenshare content at the particular location using an artificial intelligence model.

9. The method of claim 1, further comprising:
translating, by the process, the comment into a format that is compatible with the document type.

10. The method of claim 1, further comprising:
adding the comment to the screenshare content at a particular location within the screenshare content by executing a visual entity recognition module that is configured to associate an entity associated with the screenshare content and the input.

11. An apparatus, comprising:
one or more network interfaces to communicate with a network;
a processor coupled to the one or more network interfaces and configured to execute one or more processes; and
a memory configured to store a process that is executable by the processor, the process comprising:
determining one or more attributes associated with screenshare content displayed by a computer application to determine a document type associated with the screenshare content;
receiving, by the process, an input from one or more participants in a meeting hosted by the computer application, wherein the input corresponds to a comment made by the one or more participants in the meeting regarding the screenshare content;
adding, by the process, the comment to the screenshare content at a particular location within the screenshare content based, at least in part, on a time at which the comment was made in the meeting; and
processing, by the process, the screenshare content to store the comment at the particular location within the screenshare content based, at least in part, on the document type associated with the screenshare content.

12. The apparatus of claim 11, wherein the one or more attributes associated with the screenshare content comprise a file extension associated with an application that was used to create the screenshare content.

13. The apparatus of claim 11, wherein the computer application comprises a virtual meeting application.

14. The apparatus of claim 11, wherein the input comprises a voice input and wherein the process further comprises:
determining, by the process, the particular location based on the voice input.

15. The apparatus of claim 11, wherein the computer application comprises a virtual meeting application, and the process further comprises:
processing, by the process, the screenshare content to include the screenshare content and the comment at the particular location associated with the comment in a recording of a virtual meeting conducted using the virtual meeting application; and
displaying the screenshare content and the comment at the particular location associated with the screenshare content during playback of the recording of the virtual meeting.

16. The apparatus of claim 11, wherein the computer application comprises a virtual meeting application executing a virtual meeting, and the process further comprises:
adding the comment to the screenshare content based on the input from the one or more participants at the particular location associated with the screenshare content without interfering with the virtual meeting.

17. The apparatus of claim 11, wherein the particular location comprises a location selected from a group consisting of a spatial location or a temporal location.

18. The apparatus of claim 11, further comprising:
translating, by the process, the comment into a format that is compatible with the document type.

19. The apparatus of claim 11, further comprising:
adding the comment to the screenshare content at a particular location within the screenshare content by executing a visual entity recognition module that is configured to associate an entity associated with the screenshare content and the input.

20. A tangible, non-transitory, computer-readable medium storing program instructions that cause a device to execute a process comprising:
determining, by a process, one or more attributes associated with screenshare content displayed by a computer application to determine a document type associated with the screenshare content;
receiving, by the process, an input from one or more participants in a meeting hosted by the computer application, wherein the input corresponds to a comment made by the one or more participants in the meeting regarding the screenshare content;
adding, by the process, the comment to the screenshare content at a particular location within the screenshare content based, at least in part, on a time at which the comment was made in the meeting; and
processing, by the process, the screenshare content to store the comment at the particular location within the screenshare content based, at least in part, on the document type associated with the screenshare content.
